(19) United States
(12) Patent Application Publication
(10) Pub. No.: US 2003/0147774 A1
(43) Pub. Date: Aug. 7, 2003

(54) Apparatuses and methods for sterilizing soil

(76) Inventor: Alfredo Celli, Forli (IT)

Correspondence Address: YOUNG & THOMPSON, 745 SOUTH 23RD STREET 2ND FLOOR, ARLINGTON, VA, 22202

(21) Appl. No.: 10/311,256

(22) PCT Filed: Jul. 24, 2001
(86) PCT No.: PCT/IB01/01319

(30) Foreign Application Priority Data
Jul. 26, 2000 (IT) B02000A000453

(51) Int. Cl. A01N 1/00; A01C 1/00

(52) U.S. Cl. 422/28; 111/200

(57) ABSTRACT

An apparatus (10) for sterilising soil, preferably agricultural soil (13), comprising a sterilising equipment having an apparatus for administering at least a sterilising substance to said soil. The apparatus comprises means (39) for compacting the soil acting on the soil subsequently to the administration of said sterilising substance. According to another aspect, the apparatus comprises means (47) for cleaning the surface of the soil, acting on the soil before said means for administering the sterilising substance to the soil.

### TECHNICAL FIELD

The present invention relates to the field of soil sterilisation.

### BACKGROUND ART

The use of steam injected into the soil to obtain its sterilisation is known. This sterilisation system, while it is advantageous because it overcomes the pollution hazards that are present in other sterilisation systems that make use of harmful chemicals, is not very effective in the embodiments proposed so far, especially because of the considerable heat losses whereto the steam is subject after being injected into the soil. A further drawback of known steam sterilisation techniques also relates to the excessive consumption of fuel required for heating the water in order to bring to the steam state.

To obtain at least an acceptable sterilisation, prior art machines employ large quantities of steam and advance at very slow speed on the soil to be sterilised. Prior art machines are, therefore, very bulky and they lack a sufficient working range: a high number of stops are necessary to replenish water for the production of steam.

Moreover, in the field the need is felt of having available a sterilisation apparatus that exhibits a great flexibility of use, and that in particular exhibits considerable manoeuvrability, and/or is suitable for being employed on any kind of soil, however rough, and/or is able to move in restricted spaces, for instance between tall trees or in any case within existing plantations, or inside restricted environments, such as greenhouses or the like.

### DISCLOSURE OF INVENTION

In accordance with an innovative aspect, an apparatus is provided for the sterilisation of soil, preferably agricultural soil, comprising means for administering a sterilising substance to the soil, characterised in that it comprises means for compacting the soil, acting on the soil subsequently to the administration of the sterilising substance.

The compacting of the surface of the soil into which the sterilising substance is supplied allows to limit the leakage of sterilising substances, in vapour state, from the upper surface of the soil.

A greater effectiveness is thereby obtained of the sterilisation system of the present invention relative to systems of the prior art.

Additionally, the capability is obtained of treating large soil extensions and/or of attaining particularly high working rates.

According to another innovative aspect, an apparatus is provided for sterilising soil, preferably an agricultural soil, comprising a sterilising apparatus having at least a first sterilisation apparatus comprising means for administering a sterilising substance to the soil, characterised in that it comprises means for cleaning the surface of the soil.

In this way, the substrate whereon the pathogenic micro-organisms of the soil proliferate is eliminated. It is possible to employ a smaller quantity of sterilising substance, With the consequent capability of treating large extensions of soils and/or of obtaining particularly high working rates and consequent reduction in sterilisation costs.

The present invention further relates to a sterilisation method, in which a soil compacting stage is provided subsequent to the administration of the sterilising substance and to a sterilisation method, in which a soil surface cleaning stage is provided.

In preferred fashion, said cleaning of the soil surface is provided before said means for administering the sterilising substance to the soil act on the soil itself.

According to another advantageous aspect, a method for sterilising soil, preferably agricultural soil, is provided in which, following the application of at least a sterilising substance to the soil, on the surface thereon a layer of a substance is applied which react exothermically with said first substance.

The present invention further relates to an apparatus for obtaining an exothermic sterilising reaction applicable on any type of apparatus for sterilising soil and to a particular organ for the release of at least one substance, preferably in the form of vapour, into said soil.

### BRIEF DESCRIPTION OF THE DRAWINGS

Further advantageous aspects of the present invention shall become more readily apparent from the detailed description that follows, made with reference to the accompanying drawings, which show embodiments provided purely by way of non limiting examples, in which:

FIG. 1 shows a lateral schematic view of a first preferred embodiment of an apparatus for sterilising soil according to the present invention;

FIG. 2 shows a front schematic view only of the device for providing a sterilising exothermic reaction employed in the apparatus according to the first preferred embodiment of the present invention;

FIG. 3 is a perspective schematic view showing in particular, the second sterilisation apparatus used in the present first embodiment of apparatus;

FIG. 4 shows a lateral schematic view only of the second sterilising apparatus, which is maintained in a raised resting position by means of appropriate organs of the apparatus, said raising organs of the second apparatus not being expressly illustrated in this figure;

FIG. 5 shows a schematic front view of the apparatus according to the first preferred embodiment of the present invention;

FIG. 6 shows a lateral schematic view of a second preferred embodiment of an apparatus for sterilising soil according to the present invention;

FIG. 7 shows a lateral schematic view of a third preferred embodiment of an apparatus for sterilising soil according to the present invention;

FIG. 8 shows a lateral schematic view of a fourth preferred embodiment of an apparatus for sterilising soil according to the present invention;

FIG. 9 shows a lateral schematic view of a fifth preferred embodiment of an apparatus for sterilising soil according to the present invention

FIG. 11 shows a front schematic view of the second sterilising apparatus, shown in FIG. 10;

FIG. 12 shows a lateral schematic view of a sixth preferred embodiment of an apparatus for sterilising soil according to the present invention

FIG. 13 shows a partially sectioned longitudinal view of a second preferred embodiment of the means for transferring the substance to the soil;

FIG. 14 shows a lateral schematic view, partly sectioned off, of a seventh preferred embodiment of an apparatus for sterilising soil according to the present invention

FIG. 15 shows a top schematic view, partly sectioned off, of the seventh embodiment of an apparatus according to the present invention;

FIG. 16 shows a front schematic view, partly sectioned off, of the seventh embodiment of an apparatus according to the present invention;

FIG. 17 shows a sectioned view of a detail relating to the fastening and guidance area of the movable transverse equipment of the seventh preferred embodiment of an apparatus according to the present invention;

FIG. 18 shows a sectioned view of a detail relating to the bar for transferring the first substance into the soil, used in the seventh preferred embodiment of an apparatus according to the present invention.

### DESCRIPTION OF THE ILLUSTRATIVE EMBODIMENT

In all the figures that follow, the components of the sterilisation apparatus which are shared by the various preferred embodiments of the invention are indicated with the same numerical references.

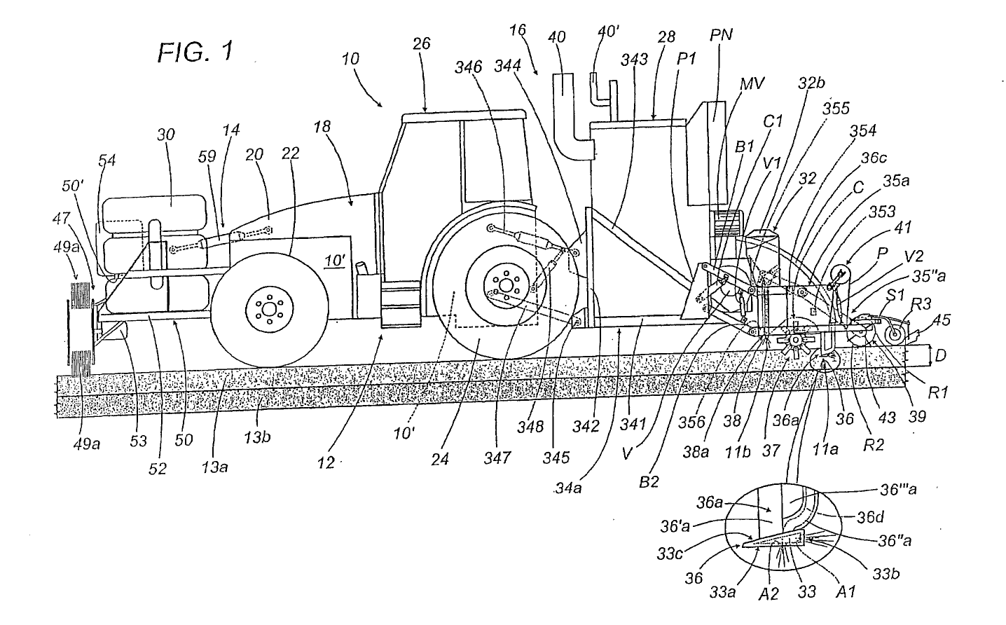

A first preferred embodiment 10 of sterilising apparatus of shown in FIG. 1.

The present apparatus 10 is composed by a self-propelled vehicle 12 and by an appropriate sterilisation apparatus, which is transported by said vehicle 12.

According to the embodiment illustrated herein, the vehicle 12 essentially comprises a body of the vehicle, which has a front part 14, a rear part 16 and lateral sides, indicated with the numerical references 18 and 19 in FIG. 5.

As shown, according to the present preferred embodiment, the body of the vehicle essentially comprises a support frame 10′, which is supported by means of a pair of front drive wheels, indicated in the aforementioned FIGS. 1 and 5 with the reference number 22, and by means of a pair of rear wheels, in turn indicated in the aforementioned FIGS. 1 and 5 with the numerical reference 24.

The engine of the vehicle 12 is not expressly shown in the accompanying figures. Said engine, however, is housed inside the hood 20 of the vehicle and is supplied a fuel contained in the tank of the tractor or vehicle (also not particularly shown in FIG. 1).

The numerical reference 26 indicates a driving station or cab, within which are provided the steering wheel, controls for driving the vehicle and possibly those for controlling the sterilising equipment. As shown, in accordance with this preferred embodiment of the present apparatus, the driving station or cab 26 is positioned between said front part 14, and said rear part 16, closer to the rear part of the vehicle.

The present apparatus for sterilising soil comprises a first apparatus for delivering to the soil a corresponding sterilising substance or agent, which is indicated in FIG. 1 with the numerical reference 11a.

This substance is, in particular, constituted by water in heated or vapour condition.

To provide for heating said water, said first sterilising apparatus comprises, therefore, a boiler 28 which vaporises or simply heats said water to a predefined temperature, before the water is transferred to the soil.

To replenish said water, the present first sterilisation apparatus comprises appropriate means for containing said sterilising water, which, as FIG. 5 clearly shows, in accordance to said first preferred embodiment, are advantageously constituted by a first and a second tanks, both indicated with the numerical reference 30.

These tanks 30 are connected by means of an appropriate conduit, not shown in the accompanying figures, to said boiler 28 and are arranged transversely equidistant relative to the median longitudinal axis of the vehicle, so that, at least under conditions of complete filling, the weight of one balances the weight of the other.

In FIG. 1, the numerical reference 40 indicates the exhaust chimney for the gases produced by the combustion of the fuel used by the boiler 28, whilst the reference number 40′ indicates the conduit of the safety vent of the boiler for the release of the steam, when said steam reaches an over-pressure state. Moreover, the reference V indicates the fan of the boiler and the reference MV indicates the motor for actuating said fan. The reference PN instead indicates the external control panel of the boiler.

Appropriate means are connected to said boiler 28 and transfer said first substance 11a to the soil.

In accordance with this first preferred embodiment, said means for administering the substance to the soil comprise a bar or blade 36 that extends transversely and, as shown in FIG. 1, is advantageously inserted, at a predetermined depth, into said soil, in such a way as to inject said first substance into the soil at the most appropriate depth, in correspondence with the specific crop to be planted in said soil.

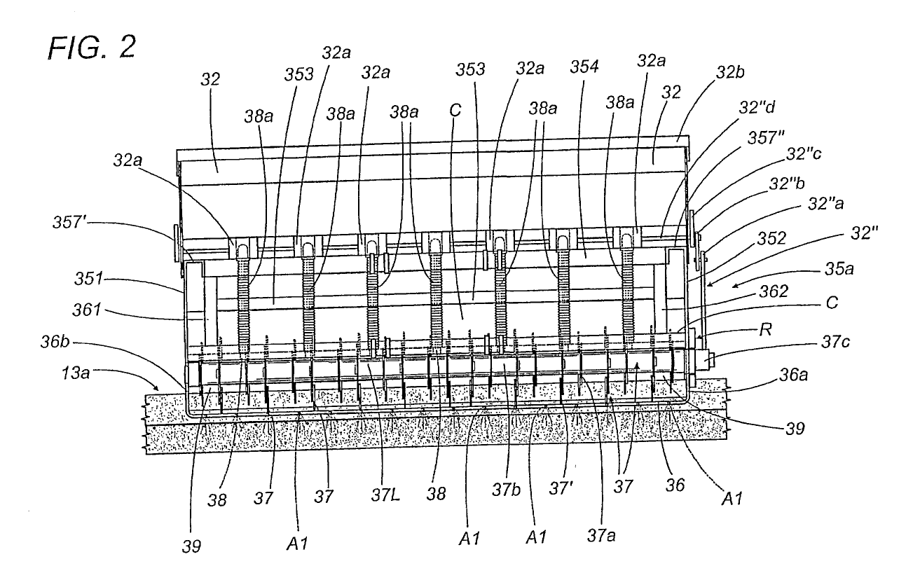

As shown in the detail of said FIG. 1 and of the subsequent FIG. 2, the transverse blade 36 has a collecting cavity 33 that extends internally to the bar 36, within which end a plurality of openings or holes A1 and A2 for transferring the substance 11a to the soil. In the detail of FIG. 1, the dashed and dotted lines show the main or prevalent directions that the jets of fluid exiting said holes in the distribution bar tend to assume.

The present transverse bar or blade 36 is provided with a short wedge-shaped triangular profile having the point end that is oriented, in use, according to the direction of advance of the vehicle 12. In particular, the wedge-shaped bar or blade 36 is provided with a lower face 33a that is held, in use, substantially oriented horizontally. Moreover, the wedge-shaped bar or blade 36 has a short rear face 33b able to position itself transversely to the direction of advance of the bar in the soil, which is substantially perpendicular to said lower face 33a. The numerical reference 33c instead indicates an upper inclined face of said blade or bar.

This conformation of the transverse blade 36 allows it easily to advance and maintain depth within the soil.

The openings for transferring the substance 11a to the soil are distributed equidistantly along said transverse bar 36.

Advantageously, a plurality of openings, indicated with the reference A2, open in the lower face 33a of the blade and allow to direct the jet of the substance 11a downwards, so as to send said first substance in depth and allow a sterilisation of the soil on site at a suitably large depth.

A second plurality of holes, highlighted in dashed lines in FIG. 2 and indicated with the reference A1, is also provided on the rear face 33b of said distributing bar 36, to send a corresponding jet of sterlising substance substantially according to the horizontal direction.

Advantageously, the present bar 36 for transferring the substance 11a to the soil is supported only by means of a first and a second lateral arms 36a, 36b, integral with the transverse ends of the bar. Said lateral arms 36a, 36b extend vertically and have a transverse profile suitable to favour the penetration of said arms into the soil and contain any resistance against their advance in the soil.

Said bar 36 and said support arms 36a, 36b are made of steel, as is the frame supporting the sterilising apparatus, described hereafter.

Advantageously, said first substance reaches the cavity 33, in the blade 36, through the lateral support arm 36a, which is internally hollow to define a conduit 36d for said first substance 11a. An appropriate tube 36c is provide for connecting the outlet of the boiler 28 with said conduit for the first substance in said arm 36c.

Said lateral arms 36a, 36b of the bar 36 have a substantially vertical front portion that has a wedge-shaped general section and a pointed end oriented in the direction of travel to favour its advance inside the soil. The vertical portion of the arm 36a is indicated with the numerical reference 36′a in FIG. 1.

The conduit 36d for the first substance is defined by an arched tubular portion 36″a, with round tubular section, which is situated posteriorly to said vertical portion 36′a and which is connected thereto by means of a stiffening plate portion 36′″a. The fact of obtaining a conduit for supplying the first substance to be injected into the soil within a support arm of the injecting bar avoids all risks of breakage and wear of said conduit. Moreover, the specific shape of the profile of the arm 36a allows a considerable flexure resistance together with a high penetration capability into the soil.

One could also use a bar for transferring the sterilising substance to the soil that has holes open in the upper surface of the bar and able to direct the jet vertically or substantially vertically upwards.

In any case, it is preferred to provide means for transferring the first substance to the soil that have such opening means as to emit a jet of steam whose prevalent emission direction is inclined by an angle relative to the vertical (in particular inclined towards the rear part relative to the direction of advance of the bar), in such a way as to limit the risk that the pressurised steam exiting said opening means lifts the superficial layers of said soil, entailing an excessively rapid escape of the steam itself through the superficial layers of the soil.

It is preferred to provide transfer means that are like those provided in accordance with a second preferred embodiment thereof which is shown in the subsequent FIG. 13, where elements similar or equivalent to those of the first preferred embodiment are designated with the same numerical references and are not commented again in detail to avoid excessively burdening the present description. The second preferred embodiment of bar 36 thus comprises a plurality of openings A3, transversely distributed along the transverse bar, which are able to send the respective jet of said first substance 11a towards the rear part or inclined upwards by a predefined angle, measured starting from the vertical direction V.

In particular, according to this preferred embodiment, the direction of the jet of said first substance 11a has, relative to the vertical V, an angle that is substantially equal to 45°.

It has been verified that such a jet inclined upwards and towards the rear part of the bar allows to carry the sterilising substance, in particular in the form of water vapour, in the area above the bar, in such a way as to affect the area in which extends the root system of certain crops, such as tomatoes, garden rocket, and others that have a root system of reduced length, for instance extending—at least in the immediate planting stage of the crop—to a depth varying from 5 to 15 cm.

Such an inclined jet remains longer inside the soil than a jet of steam directed vertically upwards, which could additionally remove the soil, opening a rapid escape way towards the atmosphere.

Moreover, the present inclined jet travels along a longer path before reaching the surface and therefore affects a greater surface of a soil, allowing an advantageous limitation of the dispersion of steam.

This angle of inclination of the prevalent direction of the jet exiting a respective hole of the means for transferring to the soil could in any case have any other desired value, suitable for the specific purpose.

Advantageously, as the aforesaid FIG. 13 shows, said plurality of openings A3 opens in correspondence with the upper edge, of said rear face 33b, joining said upper face 33c.

With the numerical reference 36e, in said FIG. 13, is indicated a rear strip for the flexural stiffening of the bar 136, which extends substantially horizontal from the rear face 33b of said bar, in a position lying between said holes A1 and said holes A3. Said strip 36a further defines a septum for separating and deflecting the jets emitted by said holes A1 and A3.

Obviously, one could also imagine a distributing bar with a lower surface that is oriented, in use, with a downward inclination relative to the horizontal.

The present sterilisation equipment further comprises a second apparatus for the delivery of a second substance or reactant able to provide, together with the first substance, an exothermic reaction that allows or contributes to the sterilisation of the soil.

Said second apparatus comprises second containment means, preferably in the form of a second container or tank 32 for said sterilising substance or reactant 11b, which is transferred to the soil through a mouth 38, defining means for administering the second substance to the soil, which opens at the end of an exhaust conduit 38a, connected to the outlet of said tank 32.

As stated, said second substance is a substance able to react exothermically with said first substance to cause the sterilisation of the soil. This second substance can be, for instance, constituted by Potassium Hydroxide (KOH), which reacts exothermically with water, as shall be better clarified farther on.

The fact that an exothermic reaction is used, which develops over a certain time interval, in addition to water vapour or to water in heated condition, allows to increase soil temperature starting from the temperature value which is imparted thereto by said vapour or said heated water, as well as to maintain in the soil, thanks to the fact that said reaction develops within a certain time interval, a sufficiently high temperature level for a longer time, suitable effectively to eliminate infesting and pathogenic agents of the soil (such as infesting weeds and nematodes), relative to what would be achievable with the use of vapour or hot water alone.

However, one could also imagine using the present apparatus as an apparatus for simple sterilisation with steam or hot water; in this case the second apparatus for the exothermic reaction would be omitted and suitable modifications could be made to the apparatus to provide a suitable support to said means for administering the first substance 11a to the soil.

In accordance with an additional embodiment, one could also image using for the exothermic reaction, instead of water vapour or hot water, water at ambient temperature, or other reactants suitable for providing an exothermic reaction; in this case, the boiler and any other heating means could be omitted. However, providing the first substance in the form of vapour is preferred.

One could also imagine using a first and a second substance able to act exothermically, which are composed of a plurality of reactants, as well as reversing the order whereby said substances are delivered to the soil.

As shown in the subsequent FIG. 2, the second tank 32 is in the form of a vat body extended transversely having an upper swivelling lid 32b for loading the second substance and presenting a plurality of devices 32a able to dispense the second substance, which means are transversely distributed at predetermined distances from each other along said vat 32. These dispensing devices are, in any case, of a known type and therefore do not require any detailed description.

These dispensing devices inject the second substance—which is preferably in solid form, for instance in granules, powder or the like—into a respective vertical conduit 38a having a corresponding lower mouth 38 for the exit and emission to the soil of said second substance.

As shown, said flexible hoses 38a, for instance made of a plastic tubular material axially compressible, have a respective mouth 38 for transferring the sterilising substance, which is held at such a height from the soil as to allow a sufficiently uniform distribution of this substance on the upper surface of the soil.

Means 37 are employed, able to break or crumble the soil, which are supported between said means 38 for administering the second reactant to the soil and said means 36 for administering the first reactant to said soil.

Said means 37 are, in particular, in the form of a rotating cutter having a plurality of tools able to break up or crumble the soil, transversely distanced from each other, which are in the form of cutting blades, indicated with the numeric reference 37′, which are oriented in such a way as to make cuts longitudinally to the transverse rotor and extend from respective supports 37a integral with a shaft or rotor 37b, in turn supported able to rotate and actuated by a corresponding motor 37c.

Said cutter means define advantageous means able to mix the soil, thereby distributing the second sterilising substance in granular or powder form, which was spread on the surface of the soil, in the layer of soil subjected to sterilising treatment.

Advantageously, both when using vapour or hot water alone, and when using an exothermic reaction, it is possible to compact the soil subsequently to the administration of the sterilising substance or substances.

Appropriate means are therefore provided, in the present apparatus, to execute said compacting of the surface of the soil.

The compacting of the surface of the soil into which the sterilising substance is provided allows to limit the escape of sterilising substances, in vapour form, from the upper surface of the soil.

A greater effectiveness of the sterilising system of the present invention than in prior art systems is thus obtained.

The present apparatus advantageously comprises means for compacting the soil, which are in the form of a soil compressing rotating roller 39, which rolling on the soil compresses it, after the sterilising substances have been added to said soil.

Said roller 39 is preferably constituted by an elongated metal cylinder, which has a smooth outer surface and which extends transversely, affecting the entire area or strip of soil subjected to the action of the sterilising means and of the soil mixing means.

The present apparatus is further provided with suitable mulching means that allow to lay a mulching sheet P over the compacted soil. The mulching sheet P that is laid over the soil is in the form of a uniform plastic film able to prevent all gas from escaping.

The mulching means comprise a reel 41 supporting the continuous mulching sheet and wheels 43 for applying to the soil the sheet adhering perfectly to the compacted soil, and a pair of lateral ridging ploughs, whereof only one—indicated with the numeric reference 45—is shown in FIG. 1.

Said ridging ploughs lift some soil laterally to the sheet P and lay it on its flanks, providing for the hermetic lateral closure of the continuous mulching sheet. In this way, said superficial compacting of the soil having made extremely smooth the surface of the soil, the mulching sheet P perfectly bears on its surface and creates no space, between the surface of the soil and the inner surface of the sheet, in which the sterilising vapour could insinuate itself. All vapour therefore remains confined in the soil, allowing a greater sterilising effectiveness.

One could also imagine laying the mulching sheet on the soil, making it pass under the soil compressing roller. In this way, one would avoid using wheels or rollers able to lay said sheet over the soil.

A wheel R, having radial projections R1 for meshing with the soil, actuates through a chain transmission 32″ the means 32a for dispensing the second substance or reactant.

This chain transmission has, as is particularly evident with reference to FIG. 2, a first, a second and a third chains 32″a, 32″b, 32″c which are wound on corresponding transmission sprockets and are such as to set in rotation a transverse shaft 32″d able simultaneously to actuate the dispensing means 32a.

Said wheel R is advantageously supported coaxially to said compressing roller 39. As shown, said compressing roller 39 is supported by means of respective lateral extension pivot pins.

One of the pivot pins for the rotating attachment of the roller 39 to the support frame further defines the central support pivot pin of the wheel R. As shown, said wheel is composed of a hub R2 supported by spokes R3 which extend in said projections R1.

According to a further advantageous aspect, means 47 for cleaning the surface of the soil are employed, which act on the soil before said means for administering the sterilising substances to the soil.

Said means for cleaning the surface of the soil are positioned anteriorly to the movable apparatus 10 and comprise means 47 able to remove material comprising plants/and or plant residues from the surface of the soil.

The means 47 for cleaning the surface of the soil comprise tine means 49 which, preferably, are inserted into the superficial layer of the soil and means for actuating the tines 49, in such a way that the tines drag and remove said material from the soil in front of the apparatus.

Said tine means are constituted by respective cleaning forks 49a. A plurality of said cleaning forks 49a are actuated continuously and in mutual succession along a horizontal path for removing said plants or residues thereof laterally to the vehicle.

Said means for actuating the tines 49a comprise a first and a second chains, only one indicated with the reference 51 being shown in FIG. 5, which are guided along a route enclosed in a loop having a lower lateral displacement segment. The chains for actuating the plurality of forks are driven on respective lateral wheels supported by sustaining metal plates 57, which are fastened to a frame 50 anterior to the vehicle. The numeric reference 53 indicates in FIG. 1 a box for gears which serve to transmit motion from a corresponding front drive of the vehicle (not expressly shown in the accompanying figures) to the drive chains 51.

As shown, according to the present first embodiment of apparatus first support means 34a are provided for said boiler 28, which extend posteriorly to the vehicle and are supported thereby.

A steam generator or boiler is to be used which has a considerable work capacity and, hence, a large size.

Preferably, the present embodiment of apparatus has a boiler 28 which is constituted by an instantaneous vaporisation boiler, without heat accumulation, having a productive capacity that can vary from 1200 to 1800 kg/h and a weight ranging between 1,200 and 1,800 kilograms. The maximum operating pressure of the boiler is equal to 12 atmospheres.

As shown in said FIG. 1, said means for supporting the boiler advantageously comprise a supporting frame 34a that defines a lower bearing plane 341, from which extend vertical front elements 342 and lateral elements 343 connecting respective vertical elements 342 to the lower bearing plane 341.

Vertical gussets 344, 345 integral with corresponding vertical elements 342 of said supporting frame 34a, define means for attaching the frame 34a to the rear part (indicated in dashed lines) of the vehicle frame 10′.

Obviously, a pair of said gussets 344, transversely distanced from each other, and a pair of gussets 345, transversely distanced from each other, will be present, each for a corresponding fastening organ.

Said means for attaching the frame 34a to the rear part of the vehicle frame preferably comprise a first and a second arms 346, 347, able to define an articulated parallelogram connection that allows to maintain the orientation of said frame 34a. These arms 346, 347 have respective ends that are connected in freely rotating fashion to the rear end of the vehicle frame and to the respective gussets 344 and 345 of the frame 34a.

Jack means 348 act between the rear part of the vehicle and the corresponding arm means 346 to provide for lifting, respectively, for lowering the frame 34a that bears the boiler 28.

As shown in FIGS. 1 through 4, an appropriate frame 35a is provided for supporting the main components of said second apparatus for administering said reactant for the exothermic reaction, as well as the compressing, mulching, mixing means and the means for transferring the first substance to the soil. Said second supporting means 35a are, in this second preferred embodiment, connected posteriorly to the support frame 34a for the first sterilising apparatus.

Said support means 35a for the second apparatus comprise a first part 35′a able to be fastened to said apparatus and a second part 35″a that is connected in articulated fashion to said first part 35′a.

The first part 35′a of the means for supporting the second apparatus comprises a first and a second lateral plates 351, 352, which are made integral to braces 353 and 354, and to a plate shaped in arched fashion. This transverse shaped plate, which is indicated with the reference C, further defines a protective case for cutter means 37 for breaking the soil.

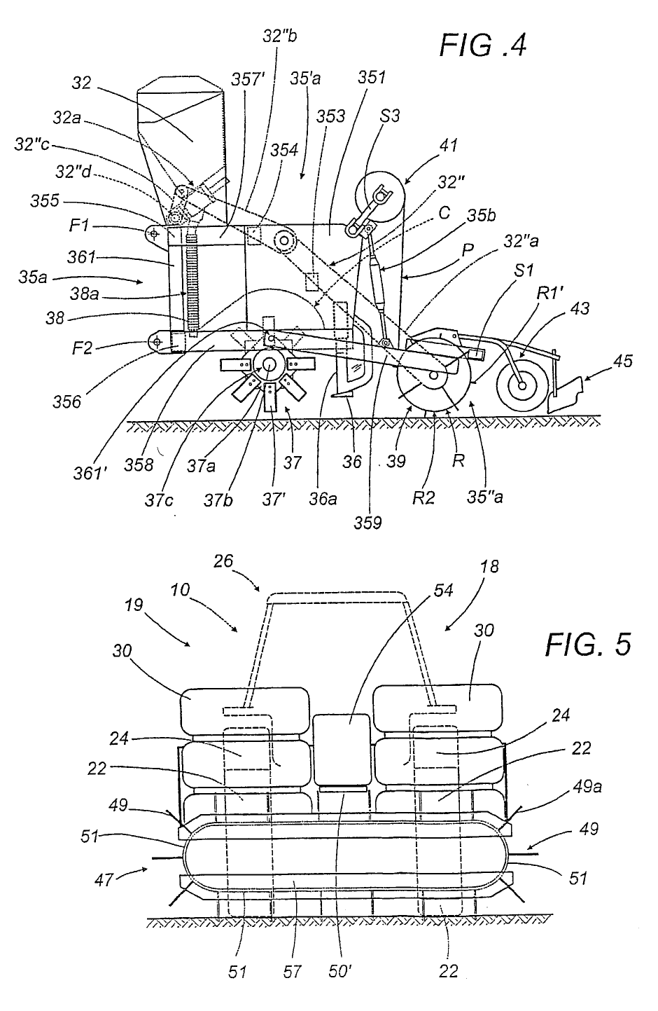

The frame of the first part 35′a of the means for supporting the second apparatus further comprises a pair of upper lateral spars 357′ and 357″ and a pair of lower lateral spars, whereof only one—indicated with the numeric reference 358 —is shown in FIGS. 1 and 4. These spars are integral with said lateral plates 351, 352.

The frame of the first part 35′a of the means for supporting the second apparatus further comprises a pair 361, 362 of front vertical uprights, which are connected to said braces 355 and 356.

Upper vertical gussets F1 and lower vertical gussets F2 extend anteriorly to the first part of the support means 35′a to define the attachment means of articulating arms B1, B2 to a corresponding lateral vertical plate P1 posteriorly integral with the frame 34a supporting the first apparatus.

A first and a second pair of said arms B1, B2 are provided, which define an articulated parallelogram connection, able to allow the rising, respectively, the lowering of the support means 35a.

Means C1 for raising said means 35 supporting the second apparatus, between a lowered sterilisation work position and a raised rest position, are provided respectively between a vertical plate P1 and the corresponding upper arm B1.

As shown, this first part 35′a of the means for supporting the sterilising apparatus supports, in addition to the tank 32 for the second substance, with the related means for the transfer of the second substance to the soil, and the means 37 for breaking up and mixing the soil, said means 36 for transferring and inserting into the soil said first substance 11a.

Thanks to said jack means C1 it is possible to raise, in the resting position, said second sterilising apparatus, or to lower the second apparatus, in a working position appropriately selected according to the desired insertion depth for the means for transferring the second substance 11b.

Screw means V1 are provided between the upper arm B1 and the lower arm B2 to allow the adjustment of their mutual distance and favour the attachment of supporting frames 35a having attachment points at different mutual distances.

The second part 35″a of the support means of the second apparatus comprises a pair of lateral spars 359, 360 which are pivotally engaged, in a respective point, to the lower lateral spars of said first part 35′a; only one of said pivotal engagement points, indicated with the numeric reference 361′, is shown in FIGS. 1, 3 and 4.

As shown, said second part 35′ of the support means of said first preferred embodiment supports said crushing roller 39 and said means 43, 45 for applying said mulching sheet P to the soil.

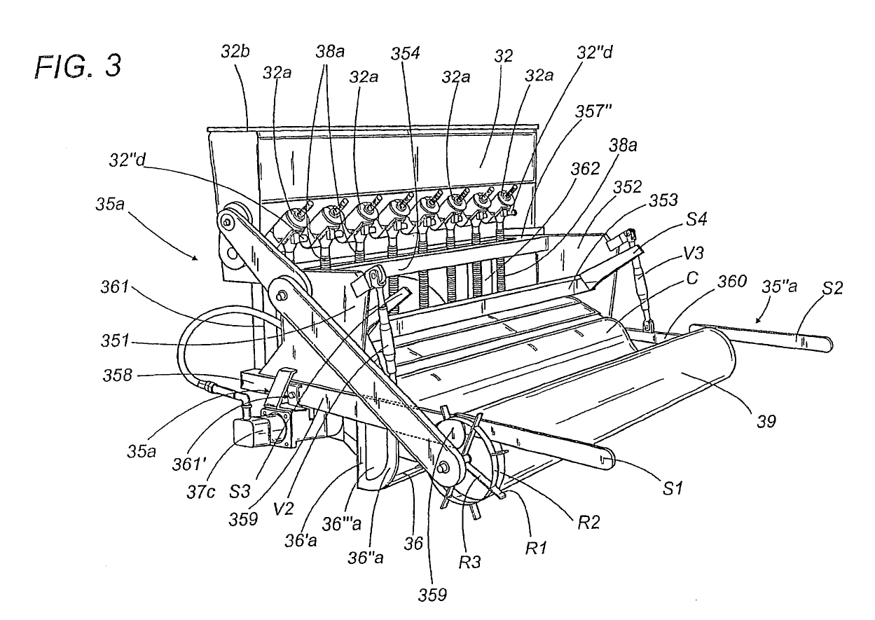

In particular, said means 43, 45 for applying said mulching sheet P to the soil are supported on stems S1, S2, which extend in overhang posteriorly from said second part 35″a, whilst additional stems, projecting posteriorly from the first part 35′a of the support means 35a and indicated with the references S3, S4 in FIG. 3, allow to support the mulching reel 41 in the raised position.

Screw means V2, V3 are provided between said first part 35′a and said second part 35″a to allow to raise, respectively, lower said second part relative to the first part so as to cause the means that are supported on said second support part 35″a to work or not to work.

As shown, the arms 346, 347 connecting said rear part of the vehicle and said frame 34a are such as to support the latter frame 34a in a suspended manner.

As shown, the aforementioned means for administering a second substance have their outlets, according to the direction of travel of the vehicle, upstream of said means for administering the first substance.

The means 30 for containing the first substance, which are in the form of a first and a second tank supported in correspondence with the front part 14 of the vehicle, bear down on a horizontal lower plane 52 of the front frame 50 defining third means for supporting the sterilising means.

The numeric reference 59, in FIG. 1, indicates an arm for the articulated connection of the frame 50 to the vehicle 12.

As shown in FIGS. 1 and 5, a tank 54 for the fuel of the boiler for heating the sterilising water is supported anteriorly to the apparatus, in particular on a respective fourth supporting frame indicated with the numeric reference 50′ in FIG. 5.

Jack means, not shown in the accompanying figures, are provided for moving said frame 50 from a lowered working position for said cleaning means 47 and a raised position of rest for said cleaning means and of free displacement of the apparatus.

This apparatus configuration is particularly advantageous, because it allows to use a boiler with considerable capacity and efficiency, with a position of the means for containing the water that is such as to balance the weight of the boiler itself and contrast any upsetting effect that such a heavy boiler imparts to the vehicle.

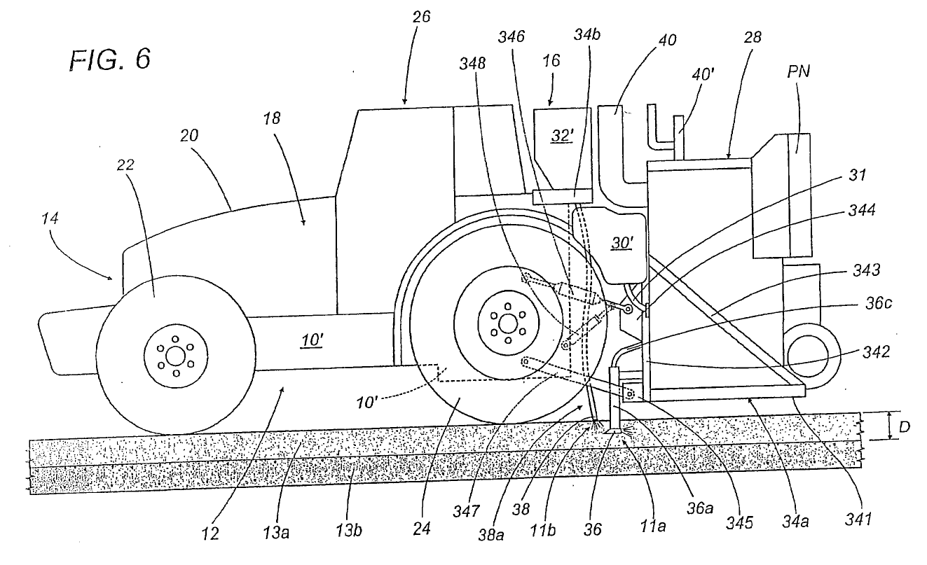

FIG. 6 shows a second embodiment of apparatus for the administration of substances 11a, 11b to an agricultural soil 13a. The same numeric references of FIG. 6 indicate the same components as in the first embodiment and, therefore, need not be re-described in detail.

As FIG. 6 shows, in this second preferred embodiment, first means 34a for supporting said boiler 28 extend posteriorly to the vehicle and are supported thereby.

Advantageously, said support means 34a, which extend posteriorly to the vehicle and which support said boiler 28 for heating the first substance, also sustain said tank 30′ for containing said substance.

In FIG. 6, the reference number 31 indicates a conduit, in particular a flexible rubber hose, for the delivery of the first substance towards the boiler 28.

Mounting the equipment on the vehicle in the rear position, it is possible to obtain a self-propelled vehicle for treating the soil, in particular for sterilising the soil, which can advantageously be employed also in conditions in which manoeuvring room is limited and in which environmental conditions are particularly difficult.

This configuration of apparatus is particularly advantageous, because it allows to use a boiler of considerable capacity and efficiency, with the position of the water tank 30′ that is such as to balance the weight of the boiler itself. In particular, in relation to the lower hinge point of the support frame, as shown in FIG. 6, said position of the tank for the first substance provides, relative to the fastening point of the lower plane of the frame supporting the boiler, a substantially opposite momentum to the one provided by the weight of said boiler.

As shown in FIG. 6, the present vehicle further comprises a second tank 32′ for a second substance 11b for treating the soil which is transferred to the soil through a mouth 38 at the end of an exhaust conduit 38a connected at the outlet of said tank 32.

According to said second preferred embodiment, said tank 32′ is advantageously supported, by supporting means 34b connected to the vehicle frame, in correspondence with the rear part 16 of the vehicle.

As FIG. 6 shows, the second tank 32′ is supported in raised position relative to said first tank 30′ in a closer position to the rear part of the vehicle, in particular, in a position to the rear of the cab 26 of the vehicle. In this way, one obtains a disposition of the weights in greater vicinity to the axle of the rear wheels, which allows to limit the upsetting effects of the weights of the present apparatus relative to the rear wheels of the vehicle.

As shown, the transverse blade 36 for administering the steam into the soil is in this second embodiment supported to said frame 34a for the boiler 28.

Connecting means 346, 347, 348, similar to those of the first embodiment are provided between said rear part 16 of the vehicle and said frame 34a. Said connecting means are such as to support said frame 34a in suspended fashion and to lift, in condition of rest and road travel of the vehicle and, respectively, lower, in working condition, said frame 34a, with the introduction into the soil of said bar means 36 for transferring the first substance 11a to the soil.

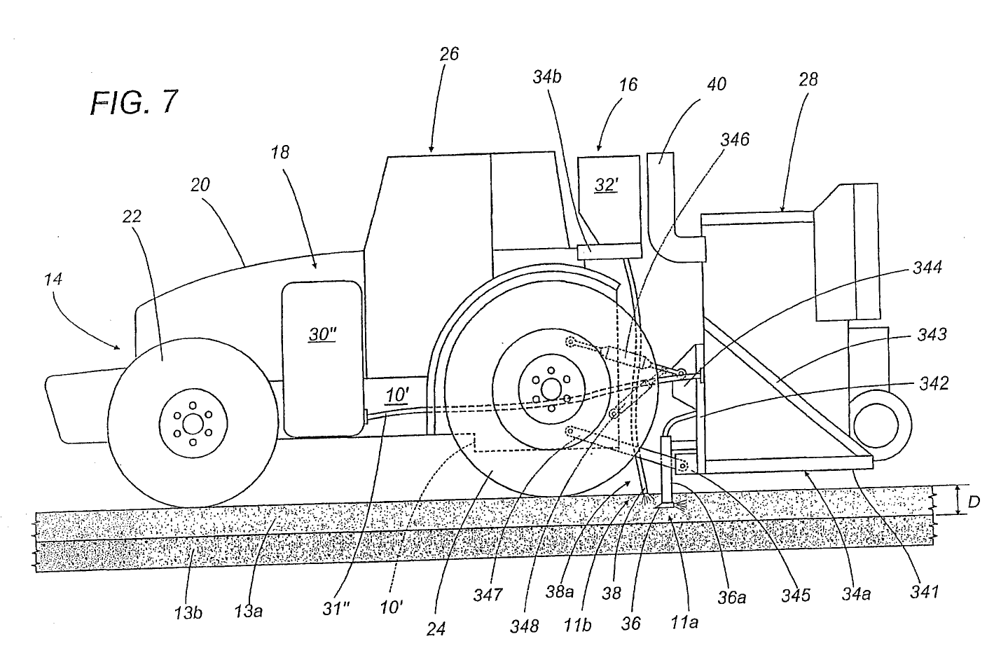

In accordance with a third preferred embodiment shown in FIG. 7, where the same numeric references indicate the same components as in the previous embodiments, it is advantageously provided for the means 34a, extending posteriorly to the vehicle and supported thereby, are destined only to support said boiler 28 for treating the same substance, whilst a tank 30″ for the first substance, preferably constituted by water, is supported in correspondence with the flank 18 of the vehicle.

In particular, the tank 30″ for the soil treatment water is connected to the boiler by means of a respective conduit 31″ which extends along the flank 18 of the same vehicle supported thereto.

One obtains, also with said third preferred embodiment, a weight disposition that allows a good balancing of the vehicle, which allows it to be advantageously employed even on particularly steep slopes, minimising the risk of upsetting, without thereby entailing an increase of the length of the front part of the vehicle. The tank 30″ can advantageously be maintained in correspondence with the area between the front and rear wheels of the vehicle, without substantially projecting from the transverse contour of the vehicle.

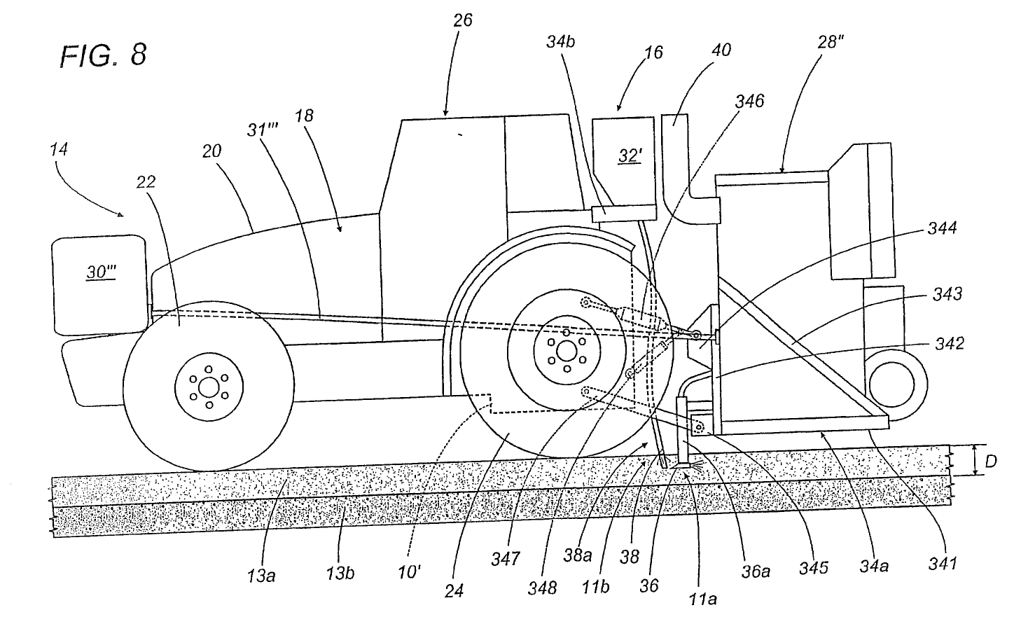

In accordance with a fourth preferred embodiment shown in FIG. 8, where the same numeric references indicate the same components as in the previous figures, it is advantageously provided for the means 34a, extending posteriorly to the vehicle and supported thereby, to be destined only to support said boiler 28 for treating the same substance, whilst a tank 30′″ for the first substance, preferably constituted by water, is supported in correspondence with the front part of the vehicle. The reference 31′″ in this FIG. 8 indicates a conduit that extends along the flank 18 of the same vehicle and supported thereby, which connects the tank 30′″ to the boiler 28.

In this way, a weight transfer is obtained from the rear part to the front part of the vehicle, with a greater balancing of the vehicle, which allows it to be advantageously employed even on particularly steep slopes, minimising risks of upsetting.

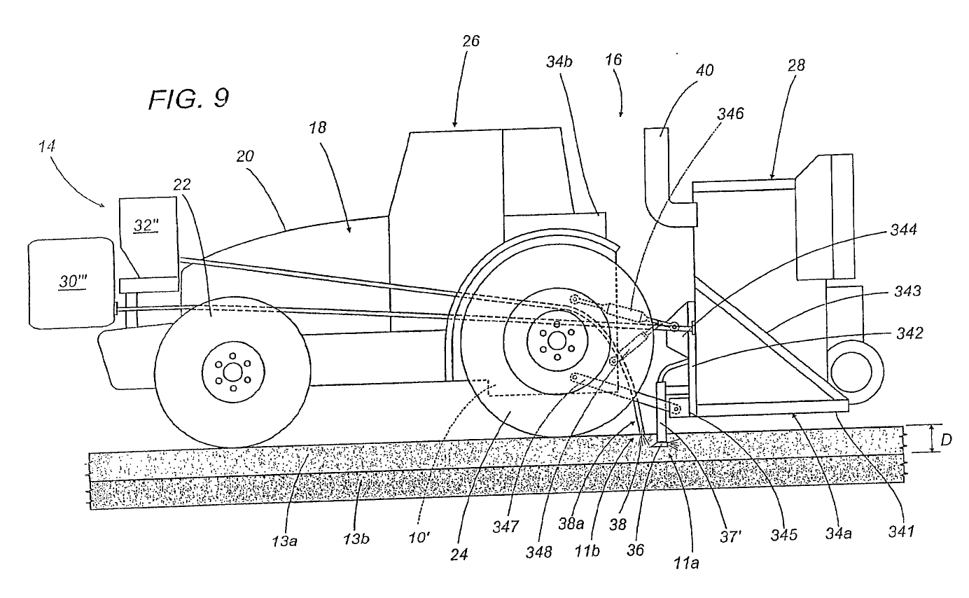

In accordance with a fifth preferred embodiment shown in FIG. 9, where the same numeric references indicate the same components as in the previous figures, it is advantageously provided, similarly to the third embodiment of FIG. 2, for the means 34a, extending posteriorly to the vehicle and supported thereby, to be destined only to support said boiler 28 for treating the same substance, whilst a tank 30′″ for the first substance, preferably constituted by water, is supported in correspondence with the front part 14 of the vehicle.

With yet more advantage, this fifth preferred embodiment provides for a second tank 32″ for a second substance 11b for treating the soil to be supported in correspondence with the front part 14 of the vehicle. In particular, said second tank 32″ is positioned between said first tank 30′″ and the front part 14 of the vehicle and is supported by means 34′b able to be fastened to a front extension of the frame 10′ of the vehicle.

An advantageous disposition of the weights of the equipment is thereby obtained, which entails an advantageous balancing effect on the vehicle, in view of its working travel, in particular in the presence of particularly steep slopes.

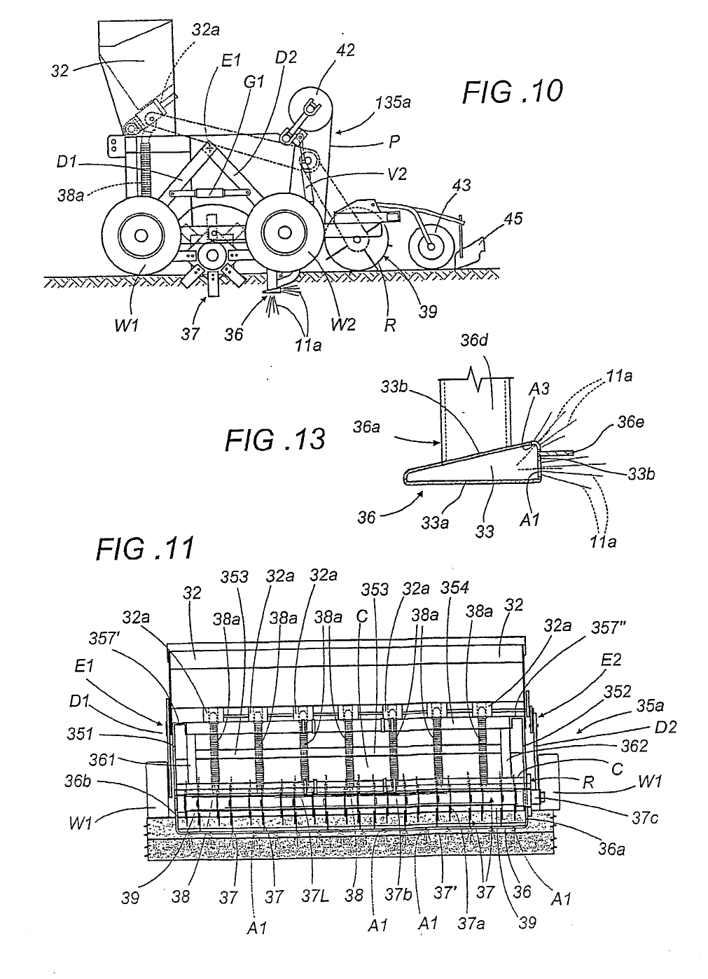

FIGS. 10 and 11 show a second preferred embodiment for the support means of the second sterilising apparatus.

In FIGS. 10 and 11, elements which are similar or equivalent to those of the first preferred embodiment of said second sterilising apparatus maintain the same references and hence need not be re-described in detail.

This second embodiment 135a of the supporting means of the second sterilising apparatus differs from the first embodiment in that it has a first pair of front wheels, indicated with the references W1, and a pair of rear wheels indicated with the references W2, which are able to travel on the agriculture soil supporting said frame 135a.

Each of said front wheels W1 is borne on an appropriate arm D1, whilst each of said rear wheels W2 is borne on an appropriate arm D2. Respective arms D1 and D2 are pivotally engaged by means of a common pivot pin to the frame 135a.

In FIG. 11, the references E1 and E2 indicate the points for the pivotal engagement to the frame 135a of each lateral pair of arms D1 and D2.

The arms D1 and D2 of corresponding front wheels W1 and rear wheels W2 are connected by means of appropriate displacement means G1, preferably constituted by a screw that is actuated in such a way as to be able to move, respectively, farther away and closer said arms D1 and D2 supporting the wheels W1 and W2, thereby lowering, respectively, and raising said frame 135a relative to the soil. In this way it is possible to adjust the working height of the means for treating the soil borne on the frame 135a and in particular to adjust the depth of insertion into the soil of said means 36 for transferring the first substance 11a.

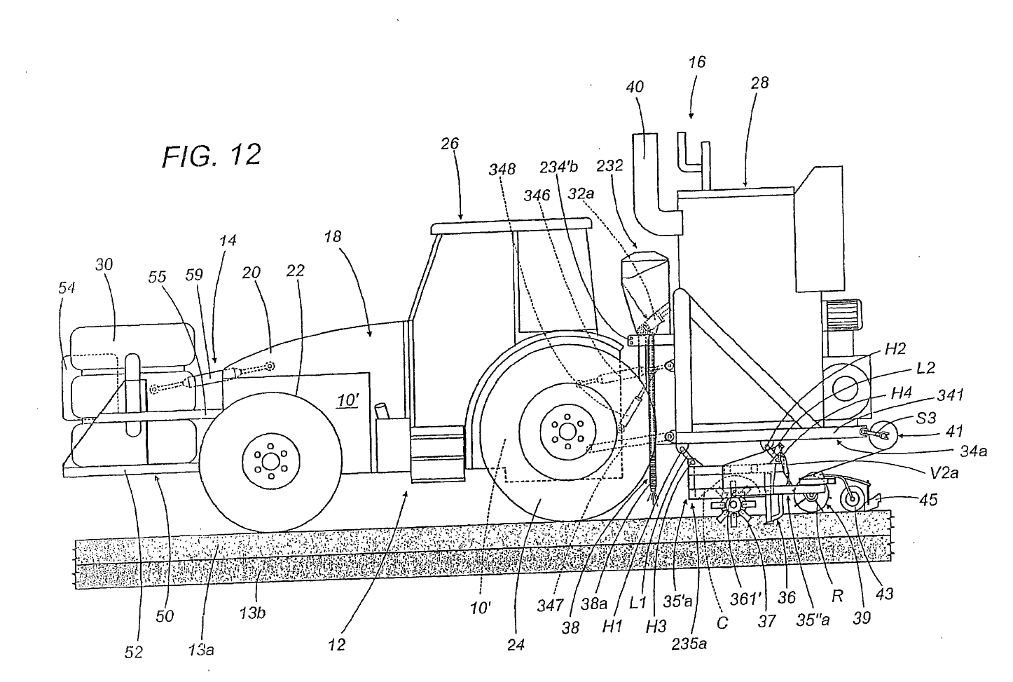

FIG. 12 shows a sixth preferred embodiment of a sterilising apparatus according to the present invention.

In FIG. 12, elements similar or equivalent to those of the first preferred embodiment maintain the same references and therefore need not be re-described in detail.

This second embodiment of apparatus differs from the embodiment in that the present frame 235a supporting the second sterilising apparatus is supported below the frame 34a supporting the first sterilising apparatus.

Said frame 34a comprising articulating gussets H1 and H2 which extend downwards, defining a hinge point for corresponding levers L1, L2, whose other end is connected, in articulated fashion, to corresponding gussets H3, H4 extending upwards from the frame 235a to support the components of the second sterilising apparatus.

This configuration of the apparatus allows to minimise its length. Moreover, the connection with articulated levers between the frame 235a, which supports the components of the second sterilising apparatus, and the overlying frame 34a, which supports the boiler 28 of the first sterilising apparatus, allows the relative lifting of the frame 235a with respect to the frame 34a, allowing it to follow the profile of the soil, maintaining the depth of the means for transferring to the soil always at the same depth relative to the upper surface thereof. It is particularly advantageous to use the present apparatus also in conditions of rough soil, with a considerable number of depressions and uneven spots.

As shown in FIG. 12, the bearing base 341 of the frame 34a supports the support stems of the mulching reel 41. Only one of said stems, indicated with the reference S3, is shown in FIG. 12.

Moreover, the tank 232 for the second substance is supported here by means of a respective frame 234′b.

In preferred fashion, the second substance could preferably be constituted by potassium hydroxide, which placed in contact with water vapour generates an exothermic reaction whose final products are K⁺ and OH⁻. This reaction allows to correct the excessive acidity of the soil by supplying alkaline ions OH³¹ and provides nutritional elements for the crops (K⁺ ions).

In this way one obtains, compared to the use of steam alone, a higher temperature (thanks to the heat contribution provided by the exothermic reaction), a longer permanence of the high temperatures reached (thanks to the development of the exothermic reaction that prolongs over time), and a sort of “caustic” effect, which the exothermically reacting elements generate with the water present in the tissue of the parasites and infesting organisms of the soil.

The steam distributing bar is preferably introduced in the soil at a depth of 15-20 cm.

The treated area of introduction of the bar could be extended to a depth D of around 30 cm. Greater depths could, however, be reached.

The numeric reference 13b, in FIG. 6, indicates the untreated layer of hard soil not infested by micro-organisms and not involved with the root system of the crops.

According to experimental tests, appreciable results have been obtained using a dose of KOH from 1,000 to 4,000 kg/ha, with a speed of advance between 150 and 250 m/h.

Other usable substances are lime or calcium oxide (CaO) which reacts exothermically with water and allows to correct soil acidity and Calcium deficiency, orthophosphoric acid H₃PO₄, which corrects soil alkalinity and phosphorus deficiency. The use of natural zeolites, in particular tufaceous zeolites that can be activated with water in absorption, deabsorption reaction, so as to obtain a release of heat.

By way of example, the vehicle could have a driving engine developing a power equal to 115 HP.

A dedicated tank for the fuel of the boiler could thus be provided, or the fuel oil, needed for the boiler, could be drawn directly from the tank of the vehicle.

One could also provide for the use of appropriate purifying means of the sterilising water, which employ a ionic exchange resin, in particular cationic exchange based on Na⁺ ions.

The present sterilising equipment is easily mounted on the vehicle as such whereto it is associated and it also allows for a long operational range of the vehicle, allowing to treat large quantities of soil.

In the aforementioned preferred embodiments, mounting the sterilising equipment in the rear position allows to have a soil treating apparatus that can advantageously be employed also in conditions with limited room to manoeuvre and in particularly difficult environmental conditions.

The provision of a second sterilising apparatus mounted on an appropriate frame enables to obtain a single model of sterilising apparatus that can advantageously be applied to different types of machines, even known ones, which provide for the use of the boiler or of other means for heating the sterilising water.

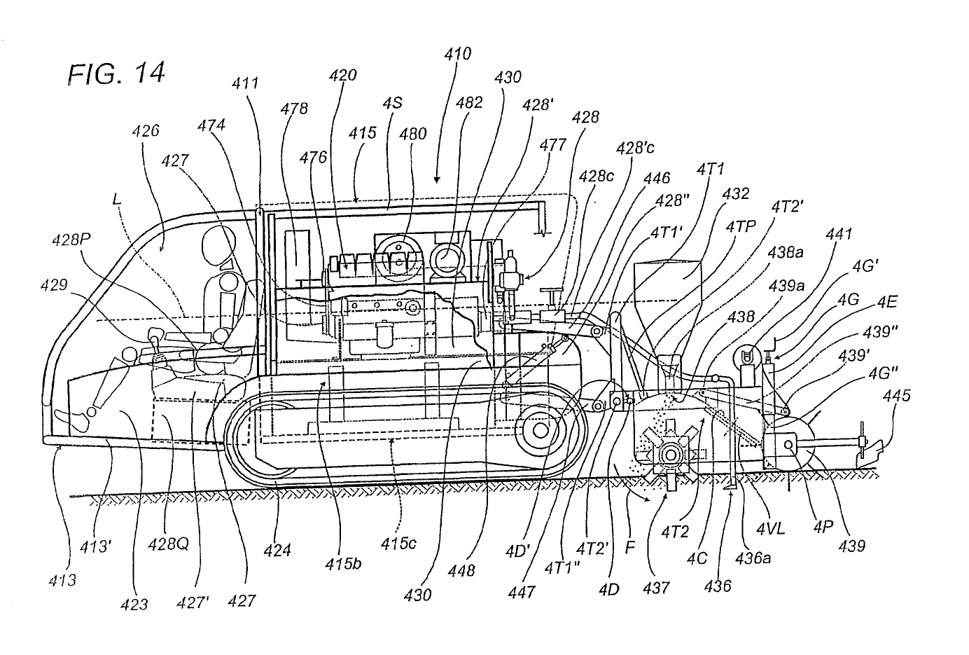

FIGS. 14 to 18 show a seventh embodiment of apparatus for sterilising soil.

This seventh embodiment of sterilising apparatus is particularly useful when operating in restricted spaces, especially inside environments, such as greenhouses, where dimensions, particularly height, must be minimised, without thereby reducing the operating range of the apparatus to an insufficient level. This seventh preferred embodiment can in any case be used in any desired environment and operating context.

This seventh embodiment 410 of sterilising apparatus comprises, as shown in particular in FIG. 14, support and locomotion means that comprise a support frame, globally indicated in the figures with the numeric reference 411.

The present support frame 411 comprises a front part 413, which defines a suitable station 426 for driving the apparatus, which driver's station 426 comprises, as show, a seat 427 for the driver and means for operating and driving the present self-propelled machine.

According to the present embodiment, levers 429 are used in particular, positioned laterally, on both sides of the driver seat 426, in such a way as to be conveniently usable by the driver.

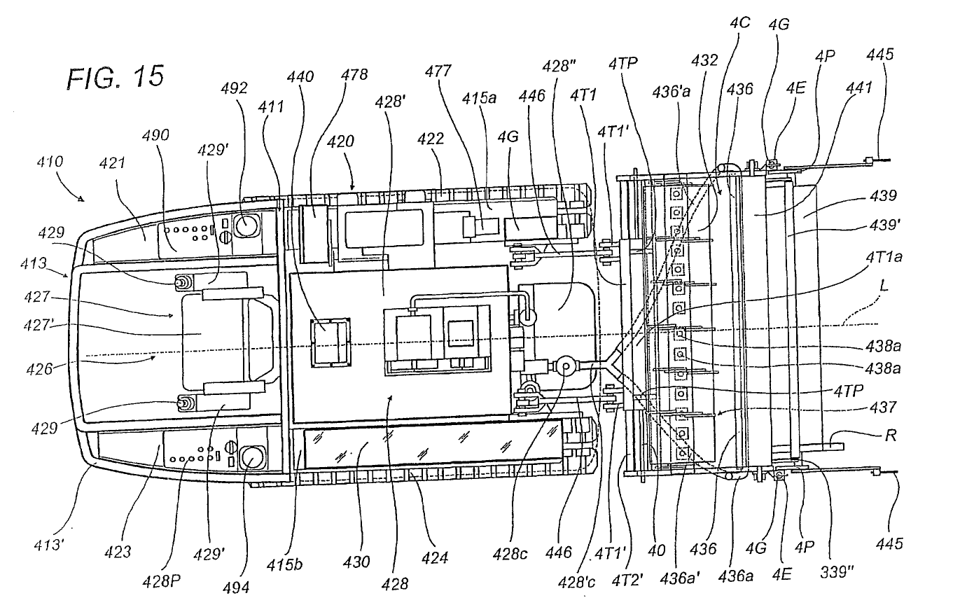

As the aforementioned FIGS. 15 through 17 show, said front part shows, in particular, base plane 413′, which projects forward in overhang from the rear part 415, better described farther on.

The present frame thus has a rear part, globally indicated with the numeric reference 415, which defines flat bed means for supporting at least part of said sterilising means of the present seventh embodiment of apparatus.

This rear part 415 of the frame comprises a platform 415c, or the like, which extends horizontally in central position, and a first and a second lateral plane 415a, 415b which extend longitudinally at the sides of said central platform 415c and are supported thereby.

As shown, suitable means for bearing the apparatus on the ground and advancing the apparatus are provided, in particular in the form of a first and a second tracks 422, 424 extending longitudinally.

As said FIGS. 15 through 17 show, said rear part 415 is supported on said ground bearing and advancing means, i.e. on said longitudinal tracks 422, 424 through appropriate axles (not shown in the accompanying figures) which support said central platform 415c.

Further provided are appropriate motor means, in particular in the form of an endothermic engine 420 and corresponding necessary components for its operation. Said engine 420 is operatively connected to, i.e. it actuates with its shaft, a pump 477, which allows the operation of the oleo-dynamic motors for the actuation of the tracks 422, 424. The operation of the tracks is, in any case, well known to the person versed in the art and hence it is not described in detail herein.

The present apparatus thus comprises an appropriate first tank 423 for a fuel substance, in particular for the fuel, preferably fuel oil, for said engine 420. Preferably, said fuel is also used to feed the burner of the heating boiler used in the sterilising apparatus, which shall be described in greater detail farther on.

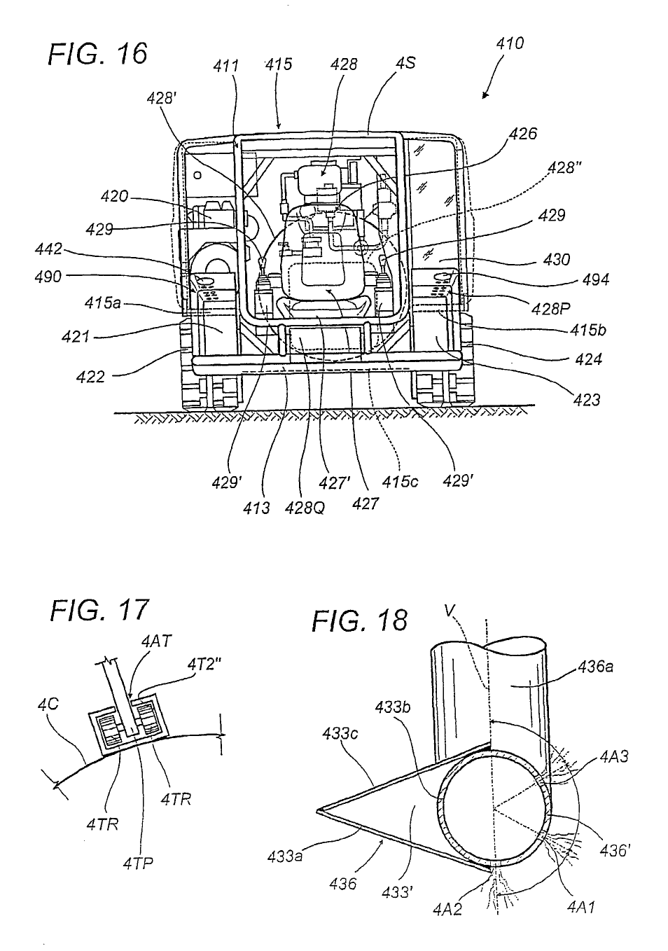

Advantageously, as shown in particular in FIGS. 15 and 16, said fuel tank 423 is supported by said front part 413 of the frame, extending to the side of the actual driver station 426, remaining at a height that is substantially equal to or slightly greater than the level of the seat 427′ of the driver seat 427. In this way, the presence of this tank does not obstruct the view of the driver, who, when operating with the present vehicle in conditions of restricted space, needs the maximum possible field of vision, in particular a good field of vision in correspondence with the area whereon the vehicle operates, in order to avoid executing inappropriate manoeuvres.

Also provided is a second tank 421 for the actuating hydraulic fluid. Said hydraulic fluid being used for means for lifting the auxiliary sterilisation means (better described farther on), or to actuate, by means of appropriate motor not shown in the accompanying figures, the cutter that breaks up and moves the soil, after the delivery of the second substance for the sterilising exothermic reaction to the soil.

As shown, said tank 421 for the actuating hydraulic fluid is sustained by said front part 413 of the frame, extending to the side of the driver station 426, remaining at a height that is substantially equal to or slightly greater than the level of the seat 427′ of the driver seat 427, in order not to obstruct the view of the driver, who needs the maximum possible field of vision to avoid executing inappropriate manoeuvres.

As shown, said first tank 423 for the fuel and said second tank 421 for the hydraulic fluid extend on opposite sides of said front part 413, in such a way as to bear in a balanced manner on the corresponding load bearing structure.

As shown in particular in FIGS. 15 and 16, the driving lever 429 advantageously extend from appropriate boxes 429′ that extend between the seat 427 and the inner face of the front tanks 421, 423.

Hence, this seventh preferred embodiment also comprises advantageous sterilising means that are able to deliver to the soil a substance suitable for the sterilisation thereof.

As previously stated in relation to the other embodiments described above, this sterilising substance can be in the form of water, which is preferably and advantageously heated to an appropriate temperature, or brought to the steam state, in such a way that it can effect, once introduced into the soil, an effective sterilising action. Said water, preferably in the steam state, can be added to the soil as such allowing to obtain a corresponding sterilisation thereof, preferably, however, said water is added to the soil (preferably in the condition of steam) in order to react exothermically with a second sterilising substance, as shall be described in greater detail farther on.

The aforementioned sterilising means comprise, therefore, means for containing said first sterilising substance, which are in the form of an additional tank 430, of high capacity, that is supported on said rear part, in correspondence with a lateral side 415b thereof, which is opposite to the one occupied by said motor means 420.

In particular, as shown, said tank for the sterilising water 430 extends longitudinally and is supported on a longitudinal base 415b, which extends at the same level as the bearing and supporting base 415a for the motor means 420.

In terms of height, said water tank 430 extends to the horizontal wall or roof of the body 4S, which is positioned in correspondence with the rear part of the present machine and covers, both superiorly and laterally, the operative means supported thereby.

The present disposition of the weights in the present seventh machine is particularly balanced and assures that no portions of the machine can crush the soil whereon it operates in an excessive and undesired manner.

Also provided are means 436 for transferring the first sterilising substance to the soil, which comprise, similarly to the previous embodiments, a transverse bar 436 able to release the first sterilising substance through transversely distributing holes.

Further provided are means 428 for heating said first sterilising substance, which are in the form of a boiler 428, that is supported on the central part of said rear part, between said motor means 420 and said water tank 430.

Said boiler 428 has a boiler body 428′ of substantially cylindrical shape, in which the water to be heated passes, which boiler body has a longitudinal axis L that extends longitudinally, in substantially horizontal direction, to the apparatus, and is supported on the central base 415c, that extends to a lower level than that of said bases 415a, 415b for bearing and supporting the motor means 420 and said water tank. This disposition of the boiler 428 is particularly advantageous because it allows, together with a sufficient operating range, to maintain a rather limited height. Moreover, weight distribution on the rear part of the machine in this way is optimal.

Said boiler 428 comprises a burner 428″, of generally box-like shape, which extends transversely to the longitudinal axis L of the boiler body and is positioned posteriorly to said boiler body, applied and sustained by the rear face 428a of the boiler body 428′. As FIG. 15 shows, the numeric reference 440 indicates the exhaust chimney for the combustion fumes produced by the burner of the boiler.

In a position vertically superior to said burner 428″ it is possible to place measuring instruments (manostat, pressure gage) relating to the boiler and housing means for devices for controlling the signals coming from the components of the boiler, which exchange said signals, through appropriate electrical wires, with central control means, preferably in the form of a control panel 428Q of said boiler, which is positioned below the seat 427.

In FIGS. 14 and 15, the numeric reference 428c indicates an outlet provided with control shutter valve, with associated control hand wheel, whereto are connected conduit means that allow the sealed supply of the first substance to the means 436 for its transfer.

In a particularly advantageous manner, in this seventh preferred embodiment of sterilising apparatus according to the present invention, an additional embodiment of the bar for transferring the fluid sterilising substance to the soil is used.

As is readily apparent with reference to the subsequent FIG. 18, said means for transferring the first sterilising substance to the soil comprise a tubular element 436′, preferably with circular cross section which extends transversely and is provided with a plurality of holes for the exit of the first substance, in the form of steam. These exit holes allow an effective and substantially homogeneous distribution of the steam in the layer of soil involved in the sterilising operation.

A first series of holes is provided, with the holes transversely distributed along the bar 436 drawn in FIG. 18 with the numeric reference 4A3, which allow to direct a jet of steam according to a direction inclined by 60° relative to the vertical V, and a second plurality of transversely distributed holes is provided, indicated with the numeric reference 4A1, which holes allow to direct a jet of steam according to an angular direction increased by 60° relative to the direction provided of said holes 4A3 and that relative to the vertical allow to direct a jet of steam oriented by about 120° as shown in said FIG. 18. Also provided is a further plurality of transversely distributed holes, which allow to direct a jet vertically downwards, substantially with a direction, of this jet, which is increased by 60° relative to the direction of the jet of steam exiting the holes 4A1. This angular distribution of the holes for emitting the jet of steam is particularly advantageous and preferred. The distribution of the steam into the soil is particularly effective and homogeneous and, moreover, this is no risk that the soil superiorly located may be lifted and allow an easy escape of the steam.

In any case, an arrangement of the holes such as to allow steams of jets directed according to one of the angular direction substantially ranging from 30° to 180°, preferably from 45° to 180°, starting from the vertical direction V, can be advantageous and imaginable for the present invention.

The best results are obtained, as illustrated in the present preferred embodiment, with an arrangement of the holes within the angular interval ranging between 60° and 180° starting from the vertical direction V.

The present means for distributing the steam to the soil comprise a front wedge-shaped portion which is constituted by a transversely elongated lower strap 433a, and an upper strap 433c, also transversely elongated, which are welded to the tubular element 436′, in correspondence with opposite vertical ends thereof and are, in correspondence with the respective opposite end, welded to each other in such a way as to define an inner chamber 433′ that is separated by a portion 433b of the circular wall of the tubular element 436′.

This chamber 433′ defines advantageous means able to keep the steam heated inside the tube 436′. The steam contained in the tube 436′ heats the air inside the chamber 433′, which keeps the semicircular separation wall 433a at a high temperature level and allows to keep the steam heated inside the tubular distribution portion 436′, avoiding temperature and pressure drops for said steam.

The steam inside the tubular element 436′ arrives from both ends through vertical lateral tubular portions indicated in the figure with the numeric references 436a, which receive the steam through a connecting conduit indicated with the numeric references 436′a branched off through a bifurcated conduit 428′c from the outlet valve 428c for the exit of the steam from the boiler. In this way the steam or sterilising fluid arrives under pressure inside the transverse conduit 436′ of the bar 436, from both transverse ends thereof, continuing towards the centre or median point of said steam transferring means. In this way the head losses undergone by said steam, before reaching the most distant holes or openings of the bar, i.e. those at the centre of the bar 436, are minimised.

As said FIG. 18 shows, the lower hole 4A2 is substantially positioned in correspondence with the welding point of the lower plate 434a to the tubular element 436′.

The plates 433a and 433c are inclined in substantially equal manner relative to the horizontal line in opposite angular directions.

The pressure of the exiting steam is preferably equal to 9 bar; in this way with the distribution of the holes 4A1, 4A2, 4A3, described above, such a steam pressure allows a uniform distribution thereof in the soil without causing inappropriate lifting and releases of the gas from the upper surface of the soil. The steam stays inside the soil for a longer time obtaining a better sterilisation efficiency. In particular, the advantageous inclination of the upper holes 4A3 prevents as well as possible the escape of steam from the upper surface of the soil, obtaining an effective spraying of the layer above the bar.

The pressure of the exiting steam can, in any case, advantageously vary from 5 to 12 bar.

In a preferred manner, in this seventh preferred embodiment of sterilising apparatus, a second sterilising substance is used, which is able to co-operate with the first substance for sterilising the soil, in particular is able to react exothermically with said first substance. This second substance could for instance be constituted by CaO.

One could in any case imagine a rear equipment provided only with the means for transferring the first substance or steam to the soil.

Said sterilising means thus comprise means for containing said second sterilising substance, which are in the form of a tank 432, supported on an auxiliary sterilising equipment able to be connected posteriorly to the present self-propelled apparatus.

Said sterilising equipment provides means 438 for transferring said second sterilising substance, which are connected to the respective tank or container 432 and are also supported on said auxiliary sterilising equipment and which will be described more thoroughly farther on.

Said auxiliary sterilising equipment, able to be fastened posteriorly to the present apparatus, further comprises, in an analogous manner to the similar embodiments described previously, means for breaking up and mixing the soil, preferably in the form of an appropriate cutter 437.

Further provided, on said auxiliary sterilising equipment, are means for compressing the soil in the form of a compression cylinder 439 positioned downstream, with reference to the direction of advance or forward travel of the vehicle, of the bar means 436 for releasing steam for the first sterilising substance.

The present seventh embodiment of apparatus also comprises means for applying a sheet of mulching material on the upper surface of the treated soil. In this seventh preferred embodiment, too, said mulching means comprise a roll or reel 441 for said mulching sheet, means for driving and applying said sheet on the soil, constituted by said roller for compressing the soil, and ploughs 445 for ridging the soil on the lateral portion of said mulching sheet.

Said auxiliary sterilising equipment advantageously comprises a main support frame 4T1 and a secondary 4T2, which supports said means for transferring the sterilising substances 436, 438 and the means 437 for breaking up and removing the soil, which is movable transversely relative to the first frame 4T1, in at least a transverse direction, in such a way as to enable operations on the soil that is in the vicinity of inclined walls of greenhouses, which would not allow a complete approach of the present sterilising vehicle, even though said vehicle has particularly reduced height.

As illustrated, said rear sterilisation equipment is connected to the main vehicle through suitable hydraulic attachment and lifting means 446, 447 that allow to lift said rear equipment, when it has to effect transferring manoeuvres. Said attachment and lifting means are in the form of hydraulic cylinders connected to an appropriate hydraulic actuation circuit.

Further provided are electrical power supply means in the form an electrical power generator 4G that are operatively connected to the drive shaft of said motor means and that are able to supply electrical power to said burner, in order to generate the electrical voltage necessary to initiate the spark that lights said burner, as well as to the means (not expressly shown in the accompanying drawings) for pumping the water into and out of said burner and to the means for the suction of the fuel oil towards said burner, which are also not expressly shown in the accompanying figures.

As shown in the aforementioned FIGS. 14 through 16, this seventh preferred embodiment is provided with a hopper 432, for the second sterilising substance, which is advantageously fitted with steep lateral walls, well suited to conveying powder material, such as the calcium oxide used herein, downwards.

Appropriate means are provided for imparting impacts or the like on said hopper 432, in order to cause the downward motion of said powdered substance, or to prevent it from sticking to the walls of the hopper.

The means 438 for transferring the second substance to the soil, comprise small pipes 438a with flared upper end connected to a corresponding lower opening of said hopper 432. Said conduits 438a have their lower end or opening 438, which opens into a corresponding hole in the covering cladding 4C to allow the fall of the material into the area of the cutter, in a position substantially aligned with the axis of rotation of the means 437 for breaking up and mixing the soil, which rotate in the angular direction shown by the arrow F in FIG. 14.

The drop of the second powdered sterilising substance above the rotating means for breaking up and mixing the soil allows to drive said substance in the direction of the arrow F and immediately to mix in the soil. In this way, it is not possible for the powder material defining the second sterilising substance to be dispersed in air. The second sterilisation substance is thus almost completely inserted into the soil, without causing any substantial dispersions thereof.

Indicated with the reference 4VL, and shown schematically in FIG. 14, a fan is provided on the rear part of the cover, which directs a flow of air downwards, in the direction of the rear part of the cutter, in order to limit the raising of dusts by the cutter.

As the aforementioned FIG. 14 shows, a transverse small roller 439′ is provided, which contacts the roller 439 with the interposition of the mulching sheet in order to keep said sheet tensioned. Said small roller 439′ is supported by corresponding lateral arms 439″, to whose free end the smaller roller 439′ is supported in rotating fashion.

Said arms 439″, whereof only one is shown in said FIG. 14, are pivotally engaged, in 439a, to the support frame 4T2 of the rear equipment.

In this seventh preferred embodiment, means are provided for the transverse displacement of the means for transferring the sterilising substance or substances to the soil.

As previously stated, said means advantageously comprise a fixed frame 4T1 which is connected to the lifting arms 436, 437, which are moved to lift the rear equipment between a working position for sterilisation and a raised position for transferring the apparatus, by corresponding hydraulic cylinders, whereof only one, indicated with the reference 438, is shown in FIG. 14.

A pair of arms 436, 437 are provided for each side of said frame 4T1. Said lifting and lowering arms 436, 437 are pivotally engaged to corresponding gussets 4T1′ and 4T1″ of the frame 4T1. The rear equipment thus comprises a second frame 4T2 which is movable transversely relative to the first frame 4T1. Inferiorly, the transversely fixed frame 4T1 has a transverse hole for the insertion of a rod 4T2′ integral with the frame 4T2, which provides means for guiding the transverse movement of said rear sterilisation equipment relative to the main machine body.

Second guiding means for the frame 4T2 are provided. Said second guiding means are constituted, as shown in FIG. 17, by rollers fastened to the frame 4T1. Said rollers, which are indicated in FIG. 17 with the reference 4TR, are inside a corresponding seat 4T2″, which slides transversely to said rollers and is integral with the movable frame 4T2, in correspondence with the curved front part of the cover 4C.

The sliding rollers for the seat 4T2″ are integral to a corresponding tie rod 4TP which is integral, in correspondence with the opposite end to the one bearing said sliding rollers, to the upper cross member of said frame 4T1. The seat 4T″ has an upper opening 4AT for the insertion of the lower end of said tie rod 4TP, which supports the corresponding roller means 4TR.

Preferably, a first and a second transversely distanced tie rods 4TP are provided for corresponding roller means. The rollers remain substantially motionless in the transverse direction and support, with the contact of their upper surface, said frame 4T2 and the equipment supported thereby, allowing a sliding by rolling of the seat 4T2″ thereof relative to said roller means.

To provide for the transverse actuation of the movable frame 4T2 relative to the transversely fixed frame 4T1, corresponding actuating means are provided, acting between said frame 4T1 and the movable frame 4T2. Said actuating means comprise a control screw indicated in FIG. 14 with the numeric reference 4D, which is fastened to said frame 4T2 and has an external thread, which by effect of the rotation of the screw 4D co-operates with a corresponding internal thread of a hole 4D′ provided in the lower portion 4T1a of said fixed frame 4T1. Making said screw 4D rotate, it is possible to move the whole sterilising equipment transversely from one side to the other of said machine, with the possibility to reach positions not reachable by the entire apparatus in spite of its limited bulk.

The present configuration of the means for supporting the rear equipment allows to obtain an equipment of minimal bulk and limited weight.

In this seventh embodiment of the sterilising apparatus of the present invention, a second preferred embodiment of the adjusting means of the towed sterilisation equipment is also illustrated.

Said height adjustment means allow to vary both the height of said cutter for breaking up the soil and mixing the sterilising substance, and of said means for transferring the first substance, in the form of steam, to the agricultural soil. Said height adjusting means of said seventh preferred embodiment comprise a tubular element 4E, positioned substantially vertical, which is fastened to the frame 4T2 supporting the rear equipment and which has an internally threaded central hole able to co-operate with the outer thread of a rod inserted coaxially into the hole of said tubular element 4E. This vertical rod is indicated in the figures with the numeric reference 4G.

Said rod 4G has an upper end 4G′, which defines a manual actuation end; said end of the rod 4G can be provided with an appropriate crank for rotating the rod 4G.

At the lower end said vertical rod 4G extends with a portion having quadrangular profile 4G″, which projects from the tubular element 4E and sustains means or sections for supporting the roller 439 for compressing the soil. Said sections for supporting the roller being indicated with the numeric reference 4P in the accompanying figures.

Said lower portion of the actuating rod 4D2 is operatively connected to the rotating actuating portion 4G1 in such a way that rotations in an angular direction or in the opposite angular direction of said rod 4G cause the raising or lowering of said roller 4T2, which bears on the soil and defines means for supporting said rear equipment of the sack.

By raising or lowering said frame 4T2 relative to said roller 439, it is therefore possible to adjust the height of the means for transferring the steam at depth to the soil and of the means for breaking up and mixing the soil.

Said shaft of the engine 420, on the side opposite that of the pump 477 that allows the actuation of the oleo-dynamic motors of the tracks, actuates a pulley 472 that is connected by means of a corresponding belt 474 to a fan 476 for aspirating the air, positioned upstream of the radiator 478 for cooling the engine 420.

The numeric reference 480 indicates, in FIG. 14, an electric actuation motor for a pump 482 feeding water from the tank 430 into said boiler 428.

Said engine 420 also actuates, through its shaft, a pump for the oil actuating the cutter that breaks and mixes the soil and an additional pump for actuating the hydraulic cylinders lifting the rear equipment. Said pumps for the cutter and for the lifting means of the rear equipment, are not particularly shown in the accompanying figures and are positioned at the side opposite said pump 477 for transmitting the motion to the tracks for advancing the present machine.

As shown in the aforesaid FIG. 14, below the driver seat 427 is provided an electrical control panel 428Q which receives the control signals and provides the safety devices for the operation of said boiler.

As FIG. 5 clearly shows, on the upper face of the tank 423 a push-button panel 428P for controlling the present sterilising apparatus is therefore provided, conveniently accessed by the operator.

On the upper face of the tank 421 are instead provided command means and gages for controlling the operation of the tracks and of the endothermic engine 420, indicated with the numeric reference 490.

In FIG. 15, the references 492 and 494 respectively indicate the caps for closing the filler pipes of the tanks 421 and 423.

Although in the present embodiment a pair of levers for controlling the advancing tracks is shown, one could nonetheless imagine providing a control device comprising a single lever on only one side of the driver station, preferably on the opposite side from the one occupied by the control push-button panel 428P, which allows to control the steam generator.

The tank that contains the water has a capacity of 600 litres of water, whilst inside said hopper for the second sterilising substance can be housed 600 kg of calcium oxide. This supply is substantially sufficient for an hour of work of the present machine. In one hour of work of the present machine, 150 linear metres of soil, for a width extension substantially equal to 1.60 m, are substantially sterilised These data are provided purely by way of non limiting example.

The present embodiment of sterilising apparatus has a height of around 150-155 cm and an overall length equal to 300-350 cm. The present disposition of the sterilising components, which are advantageously contained inside the transverse contour of the apparatus, allows to obtain a sterilising apparatus that has a particularly reduced bulk and is able to operate inside environments, for instance tunnel-shaped greenhouses, where traditional sterilisation apparatuses cannot gain access.

Moreover, according to a further embodiment, not shown in the accompanying figures, a sterilisation apparatus could also be provided which, downstream of the means for transferring the first and the second substance to the soil, in particular on the surface thereon, can apply a layer of said second substance which reacts exothermically with the first substance. In this case, the substance applied on the surface of the soil would react with the vapours of the first substance which are progressively released and escape from the surface of the soil. This additional characteristic would allow to have a slow and controlled sterilisation, by exothermic reaction, of the upper surface of the soil, which advantageously hinders the settlement of infesting plants and insects and micro-organisms that are harmful for the crops.

The application of this second layer of said second reaction substance, could be effected upstream of the compression roller, i.e. when said roller does not apply said mulching sheet upstream thereof. However, an application of this second layer of said second substance, before executing the compression stage, is preferable, since in this case the second substance pressed between the superficial particles of soil in better condition to react with the vapours of the first substance which therefore could be exploited to the highest degree.

The invention thus conceived can be subject to numerous modifications and variations, without thereby departing from the scope of the inventive concept. Moreover, all details can be replaced with technically equivalent elements.

1. Apparatus (10) for sterilising soil, preferably an agricultural soil (13a), comprising a sterilising equipment having at least a first sterilisation apparatus comprising means for administering a sterilising substance (11a) to said soil, characterised in that it comprises means (39) for compacting the soil, acting on the soil subsequently to the administration of said sterilising substance.

2. An apparatus as claimed in claim 1, characterised in that said compacting means comprise a rotating roller (39) for compressing the soil.

3. An apparatus as claimed in any of the previous claims, characterised in that it comprises mulching means (41, 45) able to lay a mulching sheet (P) on the compacted soil.

4. An apparatus as claimed in claim 3, characterised in that said mulching sheet (P) is made to pass under the means (39) for compacting the soil.

5. An apparatus as claimed in any of the previous claims or according to the pre-characterising part of claim 1, characterised in that it comprises means (47) for cleaning the surface of the soil.

6. An apparatus as claimed in claim 5, characterised in that said means (47) for cleaning the surface of the soil comprise means (49) able to remove material comprising plants and/or plant residues from the surface of the soil.

7. An apparatus as claimed in claim 6, characterised in that said means (47) for cleaning the surface of the soil comprise tine means (49) which are inserted in the superficial layer of said soil.

8. An apparatus as claimed in any of the previous claims 5 through 7, characterised in that said means (47) for cleaning the surface of the soil are supported anteriorly to said apparatus (10).

9. An apparatus as claimed in any of the previous claims, characterised in that said first sterilising apparatus comprises means (28) for heating said sterilising substance, preferably in the form of a boiler for heating said first substance (11a).

10. An apparatus as claimed in any of the previous claims or according to the pre-characterising part of claim 1, characterised in that said equipment for sterilising the soil comprises an apparatus for administering to the soil a reactant for the sterilisation of the soil itself.

11. An apparatus as claimed in any of the previous claims or according to the pre-characterising part of claim 1, characterised in that the means for administering the first sterilising substance to the soil comprise a transverse bar (36, 136) which is inserted at a predetermined depth within said soil, said transverse bar (36, 136) presenting a plurality of openings or holes for transferring the substance (11a) to the soil.

12. An apparatus as claimed in claim 11, characterised in that said bar (36, 136) for transferring the substance (11a) to the soil is supported only by means of a first and a second lateral arms (36a, 36b).

13. An apparatus as claimed in either of the previous claims 11 or 12, characterised in that said transverse bar (36, 136) and/or said first and second arms (36a, 36b) have a wedge-shaped profile which favours its penetration into the soil.

14. An apparatus as claimed in either of the previous claims 12 or 13, characterised in that at least one of said lateral support arms (36a) is internally hollow to define a conduit (36d) for feeding said first substance (11a) to the transfer bar (36, 136).

15. An apparatus as claimed in claim 14, characterised in that said conduit (36d) for the first substance is defined by an arched tubular portion (36″a) which is positioned posteriorly to said vertical portion (36′a) and is connected thereto by means of a plate-like stiffening portion (36″a).

16. An apparatus as claimed in any of the previous claims 11 through 15, characterised in that it comprises a plurality of openings (A2) able to send the jet of said first substance (11a) downwards.

17. An apparatus as claimed in any of the previous claims 11 through 16, characterised in that it comprises a plurality of openings (A3) able to emit a jet inclined upwards by a predefined angle relative to the vertical direction.

18. An apparatus as claimed in any of the previous claims 11 through 17, characterised in that said plurality of openings (A3) opens in correspondence with the upper edge of said rear face (33b) connecting to said upper face (33c).

19. An apparatus as claimed in any of the previous claims 11 through 18, characterised in that it comprises a plurality of openings (A1) which open in the rear face (33b) of the transfer bar (36).

20. An apparatus as claimed in any of the previous claims 10 through 19, characterised in that it comprises means (35a, 135a, 235a) for supporting at least part of said apparatus for the administration of said reactant for the exothermic reaction, said support means (35a, 135a, 235a) for the second apparatus being borne in a position to the rear of the apparatus (10).

21. An apparatus as claimed in claim 20, characterised in that said means (35a, 135a) for supporting said apparatus for the administration of said reactant for the exothermic reaction support said mulching means (43, 45).

22. An apparatus as claimed in any of the previous claims, characterised in that it comprises means (37) able to break up the soil, which are supported between said means (38) for administering the second reactant to the soil and said means (36) for administering the first reactant to said oil.

23. An apparatus as claimed in any of the previous claims 20 through 22, characterised in that said support means (35a, 135a, 235a) for the second apparatus support said means (37) able to break up the soil.

24. An apparatus as claimed in any of the previous claims 20 through 23, characterised in that said means (39) for compacting the soil are connected to said means (35a, 135a, 235a) for supporting the apparatus for administering the reactant able to provide an exothermic reaction.

25. An apparatus as claimed in any of the previous claims 10 through 24, characterised in that said means (35a, 135a) for supporting the second apparatus support said means (36) for administering the first substance to the soil.

26. An apparatus as claimed in any of the previous claims 20 through 25, characterised in that said support means (35a, 135a, 235a) for the second apparatus comprise a first part (35′a) and a second part (35″a) connected in articulated fashion to said first part (35′a), means (V2) are provided, between said first part (35′a) and said second part (35″a), in such a way as to move the means for treating the soil supported on said second part (35″a), between a lowered working position and a raised resting position.

27. An apparatus as claimed in claim 26, characterised in that said second part (35″a) of the means for supporting the second apparatus supports said means (39) for the superficial compacting of the soil, and/or means (43, 45) for applying said mulching sheet (P) to the soil.

28. An apparatus as claimed in any of the previous claims, characterised in that said means (37) able to break up the soil remove said soil substantially to the depth reached by said means (36) for administering the first substance.

29. An apparatus as claimed in any of the previous claims 2 through 28, characterised in that a wheel (R) for actuating the means (32a) for dispensing the reactant is mounted coaxial to said compression roller (39).

30. An apparatus as claimed in any of the previous claims or according to the pre-characterising part of claim 1, characterised in that it is in the form of a self-propelled vehicle for the administration of at least a substance (11a, 11b) to the soil, comprising a body of the vehicle (12) having a front part (14), a rear part (16) and lateral flanks (18, 19), and having motor means, and a driver station (26) between said front part (14) and said rear part (16), and in that it comprises means (34a) for supporting at least part of said first sterilising apparatus which extend posteriorly to the vehicle and are supported thereby.

31. An apparatus as claimed in claim 30, characterised in that said second means (35a, 135a) for supporting at least part (28) of said second apparatus for administering said reactant for the exothermic reaction are connected in articulated fashion to said means (34a) for supporting at least part (28) of said first sterilising apparatus, and in that means (346, 347, 348) are provided for moving said means for supporting the sterilising means between a lowered working position and a raised resting position.

32. An apparatus as claimed in any of the previous claims, characterised in that the tank (30, 30′″) for said first substance is supported in correspondence with the front part (14) of the apparatus.

33. An apparatus as claimed in any of the previous claims 5 through 32, characterised in that said means (47) for cleaning the surface of the soil are integral with support means (50) extending anteriorly to the apparatus, said support means (50) being connected in articulated fashion to said apparatus; means being provided for moving said support means (50) between a lowered working position for said cleaning means (47) and a raised resting position.

34. An apparatus as claimed in any of the previous claims, characterised in that said tank (30′) for the first substance is positioned between said means for heating the first substance (28) and the rear part (16) of said apparatus.

35. An apparatus as claimed in any of the previous claims, characterised in that said tank (30″) for said first substance is supported in correspondence with the flank (18) of said apparatus.

36. An apparatus as claimed in any of the previous claims 10 through 35, characterised in that the second tank (32, 32′, 232) for the reactant is supported by said apparatus in correspondence with the rear part (16) of the apparatus itself.

37. An apparatus as claimed in any of the previous claims 10 through 35, characterised in that said second tank (32″) is supported in correspondence with the front part (14) of said apparatus.

38. An apparatus as claimed in any of the previous claims 9 through 37, characterised in that it comprises at least a tank (54) for the fuel feeding the boiler that is supported anteriorly to the apparatus.

39. An apparatus as claimed in any of the previous claims, characterised in that it comprises means (W1, W2, D1, D2, G1) for adjusting the depth of insertion into the soil of said means (36) for transferring the first substance (11a).

40. An apparatus as claimed in any of the previous claims, characterised in that the means (235a) for supporting the components of the second sterilising apparatus are supported below the means (34a) for supporting the components of the first sterlising apparatus.

41. An apparatus as claimed in claim 40, characterised in that it comprises articulated parallelogram means (L1, L2) for connection between the means (235a) supporting the components of the second sterilising apparatus and the means (34a) supporting the components of the first sterilising apparatus.

42. An apparatus as claimed in any of the previous claims or according to the pre-characterising part of claim 1, characterised in that it comprises support and locomotion means that comprise a support frame (411), which has a front part (413) and a rear part (415), which defines supporting flat bed means for at least part of the sterilising apparatus.

43. An apparatus as claimed in claim 42, characterised in that said front part (413) defines a suitable station (426) for driving the apparatus.

44. An apparatus as claimed in either of the previous claims 42 or 43, characterised in that said front part comprises a base plane (413′) which extends in overhang forward from the rear part (415).

45. An apparatus as claimed in any of the previous claims 42 through 44, characterised in that it comprises a tank (423) supported by said front part (413) of the frame.

46. An apparatus as claimed in claim 45, characterised in that said tank (423) supported by said front part (413) of the frame extends to the side of the driver station (426).

47. An apparatus as claimed in either of the previous claims 45 or 46, characterised in that said tank (423) which is supported by said front part (413) extends to a height substantially equal or slightly greater than the seat level (427′) of the driver seat (427).

48. An apparatus as claimed in any of the previous claims 45 through 47, characterised in that it comprises a second tank (421) on said front part (413) extending on the side opposite the first tank (423).

49. An apparatus as claimed in any of the previous claims 45 through 47, characterised in that it comprises a containment tank (430) which is supported on said rear part, in correspondence with a lateral flank (415b) thereof which is opposite the one occupied by the motor means (420) for actuating the apparatus.

50. An apparatus as claimed in claim 49, characterised in that the means (428) for heating said first sterilising substance are supported on the central part (415c) of said rear part, between said motor means (420) and said tank (430).

51. An apparatus as claimed in any of the previous claims, characterised in that the boiler (428) for heating the first substance has a boiler body (428′) of substantially cylindrical shape, in which the water to be heated passes, which has a longitudinal axis (L) that extends, in substantially horizontal direction, longitudinally to the apparatus.

52. An apparatus as claimed in any of the previous claims, characterised in that the auxiliary sterilising equipment comprises a main supporting frame (4T1) and a secondary frame (4T2) which sustains at least said means for transferring the sterilising substances (436, 438) and which can be moved transversely to the first frame (4T1).

53. An apparatus as claimed in any of the previous claims 39 to 52, characterised in that said means for adjusting the height are able to raise and respectively lower the cylinder for compressing the soil (439) relative to the supporting frame.

54. An apparatus as claimed in any of the previous claims or according to the pre-characterising part of claim 1, characterised in that the second substance is conveyed into the soil by said means (436) for breaking and mixing the soil.

55. An apparatus as claimed in claim 54, characterised in that said second substance is let fall substantially on the vertical of the axis of rotation of the means for removing and breaking up the soil (436).

56. An apparatus as claimed in any of the previous claims 9 through 55, characterised in that it comprises means able to maintain a temperature for said first substance outside the heating means.

57. An apparatus as claimed in claim 56, characterised in that said means able to maintain the temperature of said first substance comprise a heated fluid that contacts the conduit (436′) in which the first sterilising substance passes.

58. An apparatus as claimed in either of the previous claims 56 or 57, characterised in that said fluid for maintaining the temperature of said first sterilising substance is housed inside an elongated chamber obtained within the bar (436) for transferring said steam to the soil.

59. An apparatus as claimed in any of the previous claims 56 through 58, characterised in that said bar (436) comprises a front wall and an upper wall defining said chamber for the fluid for maintaining the temperature of the first sterilising substance, the rear wall of this chamber being defined by a portion (433a) of the wall of the conduit for the passage of the sterilising steam.

60. An apparatus as claimed in any of the previous claims from 11 through 59, characterised in that, in said bar for transferring the first substance to the soil, such an arrangement of the holes is provided as to allow the jets of steam angularly directed according to one of the angular directions ranging substantially between 30° and 180°, preferably between 45° and 180°, and yet more preferably between 60° and 180°, starting from the vertical direction (V).

61. An apparatus as claimed in any of the previous claims 11 through 60, characterised in that, in said bar for transferring said first substance to the soil, a plurality of holes (4A3) is provided which allow to direct a jet of steam according to a direction inclined by 60° relative to the vertical (V).

62. An apparatus as claimed in any of the previous claims 11 through 61, characterised in that, in said bar for transferring the first substance to the soil, a plurality of holes (4A1) is provided which allow to direct a jet of steam according to an angular direction inclined by about 120° relative to the vertical (V).

63. An apparatus as claimed in any of the previous claims 11 through 62, characterised in that, in said bar for transferring the first substance to the soil, a plurality of holes (4A2) is provided which allow to direct a jet vertically downward.

64. An apparatus as claimed in any of the previous claims, characterised in that the pressure of the steam exiting the vaporisation means varies from 5 to 12 bar and is preferably equal to 9 bar.

65. An apparatus as claimed in any of the previous claims 45 through 64, characterised in that a push-button panel (428P) for controlling the present sterilising apparatus is provided on the upper face of a tank (423) lateral to the driver station.

66. An apparatus for administering a reactant able to provide an exothermic reaction as claimed in any of the previous claims.

67. Organ (36, 136, 436) for transferring at least a substance into the soil as claimed in any of the previous claims.

68. A method for sterilising soil, preferably agricultural soil (13), in which a sterilising substance (11a) is administered to said soil, characterised in that it comprises a soil compacting stage, executed on the soil subsequently to the administration of said sterilising substance.

69. A method for sterilising soil, preferably agricultural soil (13), characterised in that it comprises a stage of superficial cleaning of the soil.

70. A method for sterilising soil, preferably agricultural soil (13), characterised in that it comprises, after the application of at least a sterilising substance to the soil, the application, on the surface of the soil, of a layer of a substance that reacts exothermically with said first substance.
